(19) United States
(12) Patent Application Publication
(10) Pub. No.: US 2026/0077561 A1
(43) Pub. Date: Mar. 19, 2026

(54) METHOD FOR JOINING AT LEAST TWO COMPONENTS

(71) Applicants: Airbus Operations GmbH, HAMBURG (DE); Siempelkamp Maschinen- und Anlagenbau GmbH, KREFELD (DE)

(72) Inventors: Paul JOERN, HAMBURG (DE); Filipp KOEHLER, HAMBURG (DE); Lennart FINGER, HAMBURG (DE); Joerg SCHWICKERT, HAMBURG (DE); Fabian KOEFFERS, KREFELD (DE); Michael SCHOELER, KREFELD (DE)

(21) Appl. No.: 19/332,231

(22) Filed: Sep. 18, 2025

(30) Foreign Application Priority Data
Sep. 19, 2024 (EP) 24201254.0

(51) Int. Cl. B29C 65/26; B29L 31/30

(52) U.S. Cl. CPC B29C 65/26; B29L 2031/3085

(57) ABSTRACT

An in-situ thermoforming and (co-)consolidation process for joining two components together. An adaption of one of the components to the contour of the other component is done directly before a joining step with the other component in the same tooling by adapting process parameters such as heat and pressure. Also a stiffened component manufactured by such a method.

### CROSS-REFERENCES TO RELATED APPLICATIONS

This application claims the benefit of European Patent Application Number 24201254.0 filed on Sep. 19, 2024, the entire disclosure of which is incorporated herein by way of reference.

### FIELD OF THE INVENTION

The present invention relates to a method for joining at least two components, wherein at least one component comprises at least a binder system, which is in particular reactable under temperature, and a manufactured component.

### BACKGROUND OF THE INVENTION

Several processes for manufacturing stiffened components, especially in aircraft construction, are known. In most cases, the component to be stiffened and the stiffening component are fabricated separately and then joint together. If composite components are involved, this method is complex. For instance, if a ramped aircraft skin (panel) with a joggled stringer should be fabricated, the stringer must be preformed to the correct geometry and subsequently attached to the ramped skin. This may be done either via welding, bonding, riveting or co-consolidation, in both cases the positioning of the stiffener is important. The preforming is an additional process step that is needed for the stiffener manufacturing and will create additional costs in the process.

### SUMMARY OF THE INVENTION

It is therefore an object of the present invention to provide a method for joining a composite component to a dimensionally stable component, which enables a simple and time-saving connection, and a stiffened component produced by less manufacturing steps.

The object may be achieved by a method with the features of one or more embodiments described herein and by a stiffened component with the features of one or more embodiments described herein.

The invention relates to a method of joining at least two components, comprising the following steps: providing a first component which is dimensionally stable before processing and which has a first joining surface, providing a second component, comprising at least a binder system, which is in particular reactable under temperature, which is dimensionally stable before processing and which has a second joining surface that is at least partially different from the shape of the first joining surface of the dimensionally stable component, placing the first component and the second component between a lower pressing tool part and an upper tool part, deforming the second component so that the second joining surface follows the shape of the first joining surface of the first component by applying pressure and heat, and joining the second and the first components by applying pressure and heat. For the sake of clarity, the second component can be deformed partially, i.e. locally, or about its entirety. This means, the expression “the second component is deformed” in claim 1 means “the second component is deformed at least partially”. Partial deformation is naturally preferable to complete deformation from an equipment, energy, production, and economic standpoint. It is certainly much more efficient to adapt the component of the second component to the requirements of the environment and to only use mechanical, production-related, and economic resources for this adaptation in terms of energy consumption and the necessary production time. However, the inventors also recognized that in order to achieve a component structure that meets the highest quality standards, for example for use in the aerospace industry, it is not only important to ensure a first-class fit between the joining surfaces of the two components —in particular, the joining surface of the second component to the shape of the joining surface provided by the first component. This is because it can lead to stressing of the material structure, especially of the second component. Even if the appearance is flawless, the quality of the joining unit manufactured from the first component and the second component may be reduced. Despite all the disadvantages resulting from the above, it is therefore preferable to deform the second component in particular as a whole, which means that during the joint joining and forming process, at least one force flow is directed through the entire component height (Z-direction) of the second component. In this way, a first-class material structure is achieved throughout the entire joining unit consisting of the first and second components, even if the second component is only deformed in some areas during the joining process, even macroscopically, e.g., by at least 0.5 mm or at least 1.0 mm. Therefore, at least during the press and/or consolidation phase of the first component and of second component, the lower tool and the upper tool, especially the flexible (steel-)membrane, cover at least a projected area of the second component.

While the deformation, described above, relates to the cross-section of the second component in particular, it is also particularly advantageous if the second component is also deformed in its entirety in its three-dimensional structure, i.e., deformation work is carried out over its entire length, preferably in conjunction with deformations in at least one of the other two spatial directions. For instance, when the first component has a curved shape, during deforming the second component is bent over its entire length. A further example for a deformation of the second component over its entirety is a joining of the first component and the second component when the first component has in its joining area multiple steps which, together, extend over the entire length of the joining area.

The first component may be, for example, a part of a body part, especially an aircraft wing or fuselage, which may be made from the same plastics material as the second component or from a different plastics material as the second component. Even metallic materials such as aluminum or an aluminum alloy are applicable for the first component. Both are applicable, for instance, if the first component is a fuselage skin and the second component is a stringer stiffening the skin element. However, it is also possible that the first component is a stringer and the second component is a fuselage skin element. The components themselves can have a multilayer structure or a single resin matrix reinforced by fibers. The invention can be used in all applications where a joggled or formed stringer is needed to be consolidated on a body part especially on a, especially ramped, aircraft skin. Ramped skins or skins including patches are very common in aircraft design, in applications such as a fuselage, doors, flight control surfaces, essentially everywhere where a stiffened skin is usually needed. “Dimensionally stable” before processing means that the components have a rigid shape/contour when they are laid up between the tool parts. During processing, i.e. when pressure and heat is applied, at least the second component is softened so that it can be deformed without any cracks, for instance.

The inventive methods enable an in-situ thermoforming and (co-)consolidation, thus resulting in a reduction of the manufacturing effort. An additional process step during the manufacturing of the component, in particular in order to preform it to the shape required by the first component, is not needed, which will save process time, cost and tooling cost. The deformed second component is adjusted perfectly to the geometry of the dimensionally stable component, mitigating any positioning or tolerancing issues. Another advantage of this process is that a standardized component can be used as a second component, as it is adapted to the respective first component by deformation directly. Prefabrication of precisely fitting components is therefore not necessary. This simplifies and shortens the manufacturing process. The described method can also be used for the production of stiffened components in boat building or automotive engineering.

Advantageously, the second component can be a stiffener such as a straight Z-shaped stringer, wherein the first component can have at least one ramp and/or step. The first component and the second component can be positioned between the first tool part and the second tool part, wherein the first tool part and/or the second tool part can have a counter contour to the ramp of the first component, so that when the tool parts are closed (pressed together) and the second component is heated up to a first predetermined temperature, the second component can be deformed and adapted to the shape of the first component. By further heating up to a second predetermined temperature, the deformed second component can be joined to the first component. An exemplary alternative second component is a strip-like stiffener such as a laminate strip.

The first component may have one or more ramps, steps, protrusions or other deformations such as depressions. Consequently, pressing the two pressing tools together deforms the component such that its shape follows the shape of the first component.

In one embodiment, the component is heated up to its melting phase or nearly (+/−10%) to its melting phase, wherein an applied pressure is kept constant or nearly constant. By means of this, the component is prepared for plastic deformation, whereas the deformation has not started yet. The component is ready for deformation, but its initial shape is still maintained.

Advantageously, a first pressure between 2 bar and 5 bar can be applied at room temperature, preferably between 18° C. to 23° C. but even a room temperature up to 40° C. is conceivable, whereby the component can be heated to the first temperature of between 260° C. and 300° C., preferably 280° C. Thereby, the pressure can be increased slowly, for instance over a period of time of at least 1 minute, and uniformly up to a maximum pressure between 12 bar and 25 bar, preferably of 15 bar, so that meanwhile the component can be plastically deformed and its second joining surface is adapted to the shape of the its first joining surface of the first component. Then the temperature can be increased to a second temperature of between 350° C. and 380° C., preferably 365° C., and the second temperature can be maintained between 15 minutes and 30 minutes to join the component to the dimensionally stable component. The first temperature of 280° C. correspondence with the beginning of a melt phase of the used material. Then, at the higher second temperature of 365° C., inter diffusion of their molecular chains takes place, in particular if the first component is also made from materials. It should be noted that the temperatures can vary from one resin to another resin. According to this, a process is defined which allow the material to slowly form under a certain pressure at just the right temperature, so that a thermoforming of the component such as a straight stringer to a joggled stringer works. Afterwards, the temperature is raised to perform a co-consolidation of the components such as an aircraft skin to form a stiffened panel.

In order to prepare the demolding of the fabricated stiffened part, the second temperature is reduced slowly, for instance 10K/min, and uniformly to a cooling temperature of at least 140° C. The pressure can be reduced slowly, for instance over a period of time of at least 10 minutes, and uniformly from 15 bar to 0 bar. Finally, the two tool parts are opened and the manufactured component consisting of the joined second component and the first component can be removed. As a result, the temperature is uniformly lowered to the cooling temperature. This prevents possible mechanical stresses within the component. After cooling, the stiffened component (fabricated stiffened part) can be removed from the pressing tools.

Advantageously, the second component can be Z-shaped with a central strip that can be arranged parallel to a pressing direction of the two tool parts. The Z-shaped stiffener has the advantage that, in particular, the stiffness perpendicular to the contact surface of the first component is increased. However, the Z-shaped stiffener allows slight deformation when the first temperature is reached, without wrinkling or buckling of the stiffener.

Advantageously, the first component can have a ramp. As a result, the second component only has to be deformed to the same angle. With this small deformation, wrinkling of the second component is avoided. Exemplary ramps have a gradient ratio of 1:15 and 1:20 which means a ramp angle between 3° to 4°.

Advantageously, the tool parts can be dimensionally stable or can be a flexible membrane that transfers pressure to the second component and/or the first component by means of a pressure container containing a pressure medium such as oil. The pressure medium is being heated in the pressure container to achieve the desired process temperatures, in particular the second temperature. The flexible membrane has the advantage that a uniform pressure force perpendicular to the respective surface of the flexible membrane is achieved. As a result, for example, a hemispherical form of the first component and/or the second component can be compressed perpendicular to the respective surface rather than in one direction only, as is the case with stable tool parts. In this way, better deformation and adaptation of the second component can be achieved.

Advantageously, during deforming and joining the second component can be supported laterally by means of stabilizing element (core element, supporting element) so that the second component does not wrinkle or buckle when the second component is deformed. By means of such stabilizing element, the process time can be reduced as the deformation can be accelerated.

An inventive stiffened component (stiffened part) is manufactured according to the inventive manufacturing method described above, wherein the second component is a stiffener such as a stringer, rib or patch and the dimensionally stable component is an aircraft panel, a wing panel, a door frame etc.

Preferably, the second component is plastic based, in particular made of a thermoplastic or thermoset material. These materials have defined material characteristics enabling an easy processing.

### BRIEF DESCRIPTION OF THE DRAWINGS

In what follows, preferred embodiments of the present invention are explained with respect to the accompanying drawings. As is to be understood, the various elements and components are depicted as examples only, may be facultative and/or combined in a manner different than that depicted. Reference signs for related elements are used comprehensively and not necessarily defined again for each Figure. Shown is schematically in:

FIG. 1 is a side view of an exemplary inventive arrangement in an initial state;

FIG. 2 is an axial view of the arrangement from the right; and

FIG. 3 is a side view of the arrangement in a final state.

### DETAILED DESCRIPTION OF THE PREFERRED EMBODIMENT

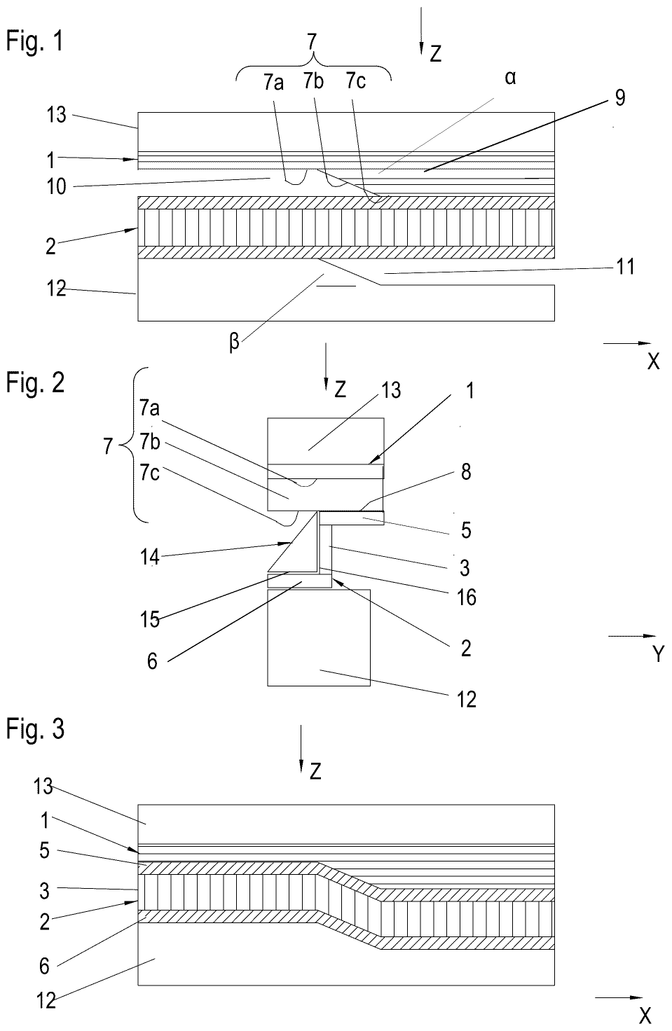

FIG. 1 shows a schematic diagram illustrating an inventive method for deforming and simultaneously joining a first component 1 and a second component 2. In the example shown here, the first component is an aircraft skin and the second component 2 represents a Z-shaped stringer for stiffening the skin in longitudinal direction x. Here, in this embodiment, both components 1, 2 are made from a thermoplastic material. Before processing, both components 1, 2 are dimensional stable. Alternatively, at least one of them is made of a thermoset material or at least one of them is made of a metal or metal alloy such as an aluminum alloy. They can be made as a laminate of the same or different material layers, for instance carbon-fiber layers and metallic layers, or as a component having a resin matrix which is reinforced by fibers.

As shown in FIG. 2, the second component 2 has a vertical web 3 extending in vertical direction z which is the pressure direction, a bottom flange 5, and a top flange 6. Before deformation, the thermoplastic component 2 is straight (initial straight shape).

The first component 1 has a first joining surface 7 and the second component 2 has a second joining surface 8, provided on its bottom flange 5. The joining surfaces 7, 8 are provided for joining the two components 1, 2 together. The joining surfaces 7, 8 are arranged one of the other in pressing direction Z.

As shown in FIG. 1, the first joining surface 7 of the first component 1 is ramped by an angle α less than 45° such that it has a lower portion 7a and inclined portion 7b and an upper portion 7c. In other words, the dimensionally stable component 1 has on its joining side a ramp 9.

The second joining surface 8 of the second component 2 has a contour that is different to the contour of the first joining surface 7. Here, the second joining surface 8 is straight. However, also a concave or a convex shape is possible.

By positioning the components 1, 2 one of the other, the first component 2 rests with the upper portion 7c of its first joining surface 7 on the second joining surface 8 of the second component 2, whereas the second component 2 is spaced apart from the first component 1 in the area of the inclined portions 7b and the lower portion 7a. Thus, before deforming, a gap 10 is formed between the second joining surface 8 and the inclined portion 7b and the lower portion 7a of the first joining surface 7.

With reference to FIG. 1, deforming and joining of the components 1, 2 are done in a single pressing tool comprising a lower tool part 12 and an upper tool part 13. In their closed state, the tool parts 12, 13 form a cavity inside which the components 1, 2 are processed. For processing, the first component 1 and the second component 2 are arranged between them, wherein in the example shown here the first component 1 is positioned on the second component 2. This means, the second component 2 is arranged on the lower tool part and deformed by moving the first component 1 downwards via the upper tool part 13.

The lower tool part 12 is rigid and has a ramp-shaped protrusion 11 with a tool angle β that is identical with the ramp angle α. As shown in FIGS. 1 and 3, the first component 1 is thus positioned between the tool parts 12, 13 that the ramp-shaped protrusion 11 is positioned in pressing direction Z opposite to the inclined portion 7b and the upper portion 7c of the first joining surface 7 of the first component 1.

The upper tool part 13 comprises several elements, from which only a flexible membrane is shown. The membrane can be pressed downwards by a pressure medium such as an oil. In order to reach required process temperatures, the pressure medium can be heated. It should be noted that executing the inventive method is not limited to such membrane tooling.

As illustrated in FIG. 2, in order to stabilize the second component 2 during its deforming at the ramp 9, a core element 14 is provided for each second component 2. As in the embodiment shown here the ramp 9 is limited to a local area of the first component 1, the second component 2 is deformed only partially, i.e. locally, and not over its entirety. The core element 14 extends in longitudinal direction and supports the second component 2 laterally. Here, the core element 14 has triangular shape. With its horizontal side 15, it rests on the bottom flange 5. With its side 16 which is perpendicular to the horizontal side 15, it is in surface contact with the web 3.

The components 1, 2 are heated by means of a not shown heating device to a first temperature indicating a melt phase of the second component 2. Here, the first temperature is 280° C. A pressure is kept at a constant level, for instance 4 bar or 5 bar.

Then, the pressure acting on the second component 2 is slowly, for instance over a period of time of at least 1 minute, and uniformly increased up to a maximum pressure, here 15 bar (indicated by the arrow 12). During this step, the second component 2 is plastically deformed and adapted to the shape of the first component 1.

With reference to FIG. 3, during deformation, the second component 2 is pressed downwards until it follows the ramped shape of lower tool part 12 such that the gap 10 the closed and the second component enters the protrusion 11. This means, the second joining surface 8 is fully in contact with the first joining surface 7, not only with upper portion 7c, but also with the inclined portion 7b and the lower portion 7a of the first joining surface 7. The non-referenced portion of the second joining surface 8 that is already in contact with the upper portion 7c of the first joining surface 7 before processing, remains basically unchanged.

After the second component 2 has been fully deformed, a joining step (co-consolidation step) is started. The temperature is raised to a second temperature, here to 365°. The second temperature is maintained for a period of time between, here 20 minutes and 30 minutes, so that the second component 2 and the first component 1 are joined on molecular basis along their joining surfaces 7, 8.

After the joining step, the demolding of the manufactured part (stiffened first component) is prepared. Therefore, the manufactured part is cooled down slowly, for instance over a period of time of some minutes, for instance at least 3 minutes, and uniformly to a cooling temperature of at least 140° C. The pressure is reduced slowly, for instance over a period of time of at least 1 minute, and uniformly from 15 bar to 0 bar. Finally, the two tool parts 12, 13 are opened to remove the manufactured part and the core elements 14 out of the cavity.

It is noted that the temperatures, pressures and period of times depend on the thermoplastic material of the second component. The values given here are exemplary given and can vary from one thermoplastic material to another thermoplastic material.

When the second component 2 is deformed over its entirety, the following should be noted:

During the heating up phase of the second component 2, the entire second component 2 is deformed.

During the consolidation phase of the first component 1 and of second component 2, the entire second component 2 is subjected to a pressure force.

Further on, during the consolidation phase of the first component 1 and of second component 2, the lower tool 12 and the upper tool 13 cover a projected area at least of the second component 2.

The invention relates to an in-situ thermoforming and (co-)consolidation, wherein a pre-deformation of a plastic-based component in order to correspondent to a contour of a component to be joint with can be omitted, as the adaption of the component to the contour of the component to be joint with is done directly before the joining step with the other component in the same tooling by adapting process parameters such as heat and pressure.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 first component
2 second component
3 middle web
4 pressure direction
5 bottom flange
6 upper flange
7 first joining surface
7a lower portion
7b inclined portion
7c upper portion
8 second joining surface
9 ramp
10 gap
11 ramp-shape protrusion
12 lower tool part
13 upper tool part
14 core element (stabilizing element)
15 horizontal side 16 perpendicular side
α ramp angle
β tool angle
X longitudinal direction
Y horizontal direction
Z vertical direction

Claimed is:

1. A method for joining at least two components, comprising the steps:
providing a first component which is dimensionally stable before processing and which has a first joining surface;
providing a second component comprising at least a binder which is reactable under temperature and which is dimensionally stable before processing and which has a second joining surface that is at least partially different from a shape of the first joining surface of the first component;
arranging the first component and the second component between a lower tool part and an upper tool part; and,
applying pressure and heat to the first component and the second component such that the second component is deformed and the second joining surface is adapted to the shape of the first joining surface, and the first component and the second component are joined together.

2. The method according to claim 1, wherein the second component reaches a melt phase or nearly a melt phase and the pressure is constant or nearly constant.

3. The method according to claim 1, wherein the applying pressure and heat comprises
a first pressure between 2 bar and 5 bar being applied at room temperature,
the second component being heated to a first temperature between 260° C. and 300° C.,
the pressure being increased to a maximum pressure between 12 bar and 25 bar, and,
the second component is heated to a second temperature between 350° C. and 380° C. and the second temperature being maintained between 15 minutes and 30 minutes.

4. The method according to claim 1, further comprising:
reducing a temperature of the first component and the second component to a cooling temperature of at least 140° C.; and,
reducing the pressure to be between 15 bar to 0 bar.

5. The method according to claim 1, wherein the second component is Z-shaped with a central web arranged parallel to a pressing direction of the upper tool part and the lower tool part.

6. The method according to claim 1, wherein the first component comprises a ramp.

7. The method according to claim 1, wherein the lower tool part, or the upper tool part, or both are stable or comprise a flexible membrane that transfers a pressure to the second component, the first component, or both with a pressure container with a pressure medium, wherein the pressure medium is heated in the pressure container to achieve a desired process temperature.

8. The method according to claim 1, wherein the second component is laterally supported by one or more stabilizing elements.

9. The method according to claim 1, wherein the second component is plastic.

10. A stiffened component manufactured by the method according to claim 1, wherein the second component is a stiffener and the first component is an aircraft panel or a wing panel.
